(19) United States
(12) Patent Application Publication
(10) Pub. No.: US 2019/0378474 A1
(43) Pub. Date: Dec. 12, 2019

(54) METHOD OF DETERMINING FITTING FUNCTIONS FOR SUB-PIXELS OF A DISPLAY PANEL

(71) Applicant: Hung-Cheng KUO, Hsinchu (TW)

(72) Inventor: Hung-Cheng KUO, Hsinchu (TW)

(21) Appl. No.: 16/540,651

(22) Filed: Aug. 14, 2019

Related U.S. Application Data
(63) Continuation of application No. 16/004,895, filed on Jun. 11, 2018.

(51) Int. Cl. G09G 5/10; G09G 3/3208

(52) U.S. Cl. CPC G09G 5/10; G09G 2320/0233; G09G 2360/16; G09G 3/3208

(57) ABSTRACT

A method of determining fitting functions for sub-pixels of a same color element of a display panel is proposed. After a plurality of fitting functions are obtained for the sub-pixels, a predetermined filtering criterion is used to re-determine a fitting function from among the obtained fitting function for each sub-pixel, thereby reducing a total number of the fitting functions used for demura operation. The predetermined filtering criterion for a sub-pixel includes a single-pixel criterion that relates to a fitting deviation, which relates to a mismatch between a fitting function and data points measured for the sub-pixel.

### CROSS-REFERENCE TO RELATED APPLICATION

This application is a continuation-in-part (CIP) application of U.S. patent application Ser. No. 16/004,895, filed on Jun. 11, 2018.

### FIELD

The disclosure relates to improving uniformity of a display panel, and more particularly to a method for determining fitting functions for sub-pixels of a display panel.

### BACKGROUND

In the display panel industry, mura, referring to non-uniformity of a display panel in terms of luminance, is always a problem to be solved. Mura may result from inability to perform consistent and satisfactory manufacturing process control, such as control of a vapor deposition process for OLED panels, a mass transfer process for micro LED panels, etc. Therefore, multiple demura (i.e., mura correction or elimination) technologies have been developed to alleviate the mura effect for the display panel. In the display panel industry, piecewise linear approximation is used to, for each sub-pixel of the display panel, obtain a fitting curve that fits a relationship between grayscale code (also called gray level) and luminance of the sub-pixel, and a voltage or current output to the sub-pixel is adjusted based on a difference between the fitting curve and a desired curve that represents a desired relationship between grayscale code and luminance for all sub-pixels corresponding to the same color element, so as to minimize deviation of the actual output luminance of the sub-pixel from the desired luminance for the same sub-pixel. However, traditional piecewise linear approximation usually fails to fit the relationship between grayscale code and luminance of the sub-pixel well, leading to poor demura outcome.

Furthermore, due to cost considerations, a display panel may only allocate limited memory capacity for the storage of curve fitting parameters related to demura operation, so how to reduce the number of curve fitting parameters while maintaining satisfactory demura result is a goal in the relevant industry.

### SUMMARY

Therefore, an object of the disclosure is to provide a method of determining fitting functions for sub-pixels of a same color element of a display panel, which may help reduce a number of the fitting functions to be used for demura operation.

According to the disclosure, the method is to be performed by a computer device, and includes: acquiring, for each of the sub-pixels, a data point set that includes a plurality of data points respectively corresponding to multiple predetermined luminance codes, wherein each of the data points is composed of the corresponding one of the predetermined luminance codes and a luminance value of the sub-pixel measured at the corresponding one of the predetermined luminance codes; obtaining a plurality of fitting functions by performing curve fitting based on the data point sets acquired for the sub-pixels; and for each of the sub-pixels, determining a filtered fitting function, which is one of the fitting functions that conforms to a predetermined filtering criterion, to fit the data point set acquired for the sub-pixel, wherein the filtered fitting functions determined for the sub-pixels are used in demura operation for the display panel. For each of the sub-pixels, the predetermined filtering criterion includes a single-pixel criterion that relates to a fitting deviation, which corresponds to the sub-pixel and which relates to a mismatch between the filtered fitting function and the data points corresponding to the sub-pixel.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram illustrating a system to implement an embodiment of a method for enhancing luminance uniformity of a display panel according to the disclosure;

FIG. 2 is a flow chart illustrating a method of determining fitting functions for sub-pixels of a display panel;

FIG. 3 is a plot showing a curve representing a desired relationship between luminance codes and luminance, and a fitting curve that fits data points measured for a particular sub-pixel;

FIG. 4 is a plot illustrating that data points measured for multiple sub-pixels are used to acquire several first reference points for demura operation;

FIG. 5 is a plot showing a result of demura operation according to this disclosure;

FIG. 6 is a flow chart illustrating how a processor implements the demura operation in the embodiment according to this disclosure;

FIG. 7 is a plot illustrating that the data point sets acquired for the sub-pixels are classified into multiple sub-pixel groups; and

FIG. 8 is a flow chart illustrating steps of how to determine filtered fitting functions for the sub-pixels.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

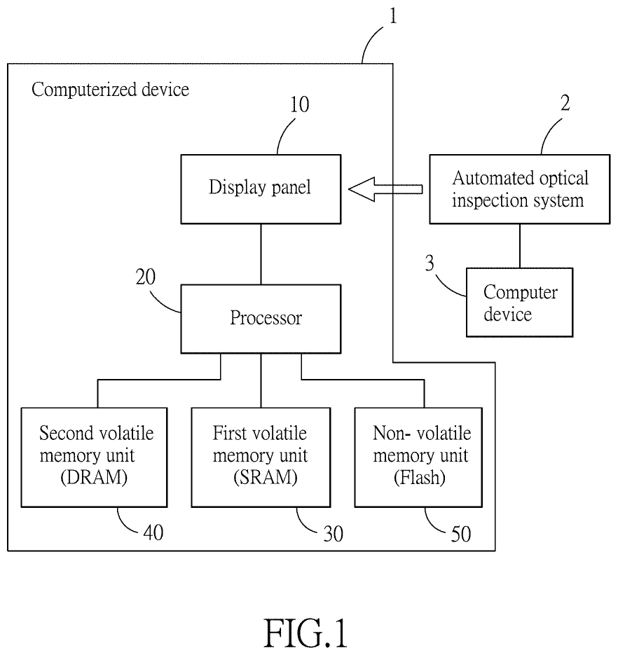

Referring to FIG. 1, the embodiment of the method of determining fitting functions for sub-pixels of a display panel 10 according to this disclosure is implemented by a computer device 3 with the assistance of an automated optical inspection (AOI) system 2. The display panel 10 may eventually be used as a component in a computerized device 1.

In this embodiment, the computerized device 1 may be, for example, a smartphone, a notebook, a television, etc., which includes the display panel 10, a processor 20, a first volatile memory unit 30, a second volatile memory unit 40, and a non-volatile memory unit 50 that are integrated together as a single product. However, this disclosure is not limited in this respect, and these components may each be an independent product in other embodiments.

In this embodiment, the display panel 10 may be, for instance, an OLED (organic light emitting diode) panel, a micro LED (light emitting diode) panel, etc., and is electrically connected to the processor 20; the processor 20 may be, as an example, an application processor that is mounted on a main board of the computerized device 1 in a case that the computerized device 1 is a smartphone; the first volatile memory unit 30 is electrically connected to the processor 20, and may be, for instance, an SRAM (static random access memory) unit including at least one SRAM; the second volatile memory unit 40 is electrically connected to the processor 20, has an access speed lower than that of the first volatile memory unit 30, and may be, for instance, a DRAM (dynamic random access memory) unit that includes at least one DRAM and that has a lower access speed (i.e., longer access time) relative to the SRAM unit; and the non-volatile memory unit 50 may be, for instance, a flash memory unit including at least one flash memory, a solid-state storage device, a hard disk drive, etc., and is electrically connected to the processor 20. It is noted that this disclosure is not limited to the abovementioned exemplary configurations.

The display panel 10 includes a plurality of pixels (e.g., 1920×1080 number of pixels for an FHD (full high definition) panel), each of which may consist of multiple sub-pixels each corresponding to a color element (e.g., a red color element, a green color element, a blue color element, etc.).

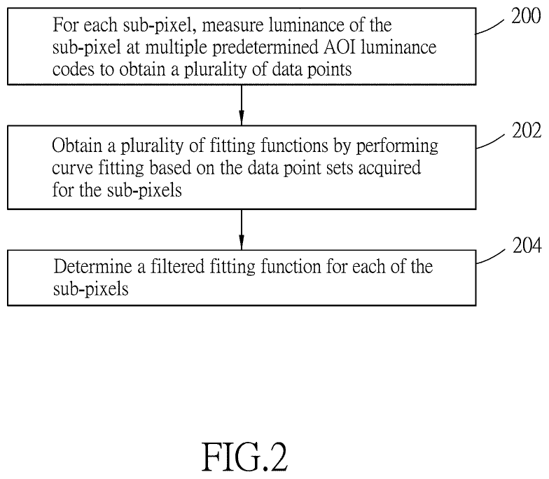

Referring to FIG. 2, in this embodiment, the AOI system 2 is used to measure (step 200), for each of the sub-pixels of the display panel 10 that correspond to a specific color element, luminance of the sub-pixel each time a different one of multiple predetermined luminance codes is inputted to drive the sub-pixel, so as to obtain, for each of the sub-pixels, a data point set that includes a plurality of data points respectively corresponding to the predetermined luminance codes, where each data point is composed of the corresponding one of the predetermined luminance codes and a luminance value of the sub-pixel that is measured when the corresponding one of the predetermined luminance codes is used to drive the sub-pixel. The automated optical inspection may be performed with the display panel 10 alone, or with the display panel assembled in the computerized device 1, so step 200 may be implemented in either a production line of the display panel 10 or a production line of the computerized device 1. It is noted that, for each of the sub-pixels, different luminance codes theoretically correspond to different values of luminance, respectively, and the luminance codes may be represented in a form of grayscale codes, control codes or voltages. A number of grayscale codes relates to a number of bits used to represent the data of each sub-pixel. For example, an 8-bit sub-pixel may correspond to 2⁸=256 shades of gray in grayscale. The control codes are used to represent voltages to be provided to the sub-pixel. For example, a voltage that can be provided by a source driver IC may range from 3V to 6V with the range being divided into 1024/2=512 voltage levels (in practice, there may be 1024 levels used for 0V to 6V, but the voltage actually used by the source driver IC may range only from 3V to 6V, corresponding to 512 voltage levels) each corresponding to a respective control code. In this example, the 256 shades of gray respectively correspond to 256 out of 512 control codes, and also 256 different voltages. In the embodiment of this disclosure, the luminance codes are exemplified using grayscale codes, but this disclosure is not limited in this respect.

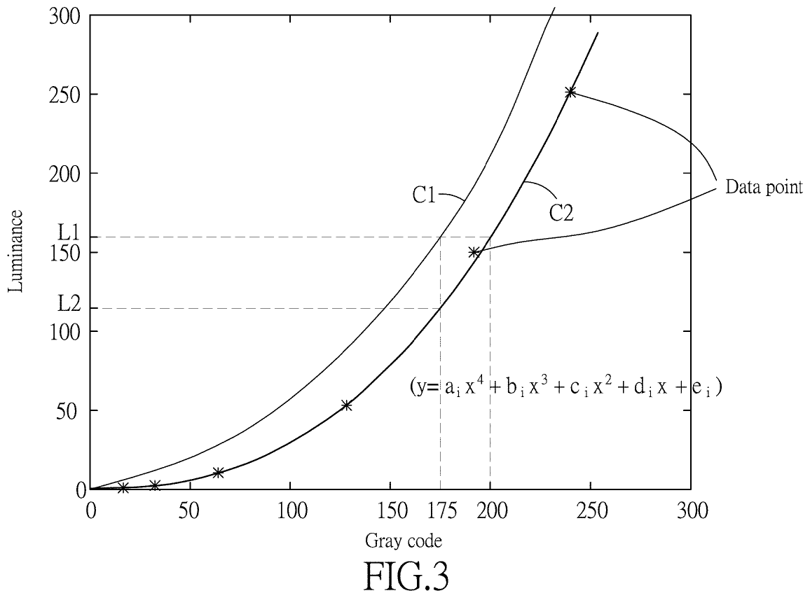

FIG. 3 is a plot that exemplarily shows a curve (C1) representing a desired relationship between luminance codes and luminance for all sub-pixels that correspond to the same color element, and several asterisks respectively represent the data points of the data point set for a particular sub-pixel obtained by the AOI system 2. Apparently, the data points do not coincide with the curve (C1), and the demura technology comes into play. In practice, it is inefficient to measure the luminance of the sub-pixel for all possible luminance codes, so curve fitting techniques can be used to acquire a fitting function that describes a fitting curve (C2) fitting the limited number of data points and it is assumed that the fitting curve (C2) well approaches an intrinsic (or actual) relationship between luminance codes and luminance for the sub-pixel. In this embodiment, the fitting function is a polynomial function (note that a piecewise polynomial function is also a type of the polynomial function) of which a degree is greater than or equal to two, but this disclosure is not limited in this respect.

Referring to FIG. 2 again, in step 202, the computer device 3 obtains a plurality of fitting functions by performing curve fitting based on the data point sets acquired for the sub-pixels.

In this embodiment, a two-stage curve fitting algorithm is exemplarily used to generate, for each of the sub-pixels, a data-points fitting function which describes a data-points fitting curve that fits the data points corresponding to the sub-pixel well and that serves as a basis for obtaining the fitting curve for the sub-pixel.

In the first stage, the computer device 3 generates a first polynomial function describing a first reference curve that represents a first reference relationship between luminance codes and luminance and that has a plurality of first reference data points each of which is composed of one of the predetermined luminance codes and a first reference luminance value corresponding to said one of the predetermined luminance codes. In one embodiment, for each of the first reference data points, the first reference luminance value relates to the luminance values of the multiple data points that correspond to the predetermined luminance code of the first reference data point.

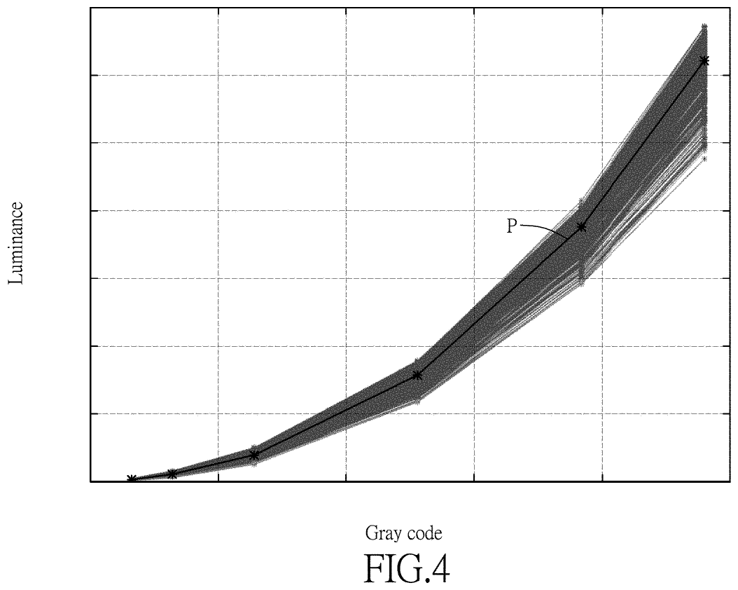

In this embodiment, the computer device 3 performs, for each of the predetermined luminance codes, averaging on the luminance values of multiple data points that respectively correspond to the sub-pixels and that all correspond to the predetermined luminance code (i.e., the luminance values of multiple sub-pixels measured when the predetermined luminance code is used to drive the sub-pixels), so as to eventually acquire the first reference data points that respectively correspond to the predetermined luminance codes. In other words, for each of the first reference data points, the first reference luminance value is an average of the luminance values of the data points corresponding to the predetermined luminance code of the first reference data point. In one embodiment, the averaging is performed based on all of the sub-pixels of the display panel 10. FIG. 4 shows a plurality of gray polylines each of which is formed by connecting the data points that correspond to a respective one of the sub-pixels of the display panel 10, and a black polyline (P) which is formed by connecting the first reference data points. For instance, the y-value of the first reference data point p₁₂₈ is an average of the luminance values of all of the sub-pixels of the display panel 10 measured at the luminance code of 128 in step 200.

Upon acquiring the first reference data points, the computer device 3 performs curve fitting on the first reference data points to obtain a first polynomial function g(x) that describes a first fitting curve fitting the first reference data points and that has a degree of N. In order to have a low system load for demura operation, N is 3 or 4 in this embodiment, but this disclosure is not limited in this respect. In other embodiments, N may be a positive integer greater than 4, or smaller than 3, depending on the requirement of the designer.

In the second stage, the computer device 3 generates, for each of the sub-pixels, a plurality of second reference data points each of which is composed of one of the predetermined luminance codes, and a second reference luminance value relating to a difference between the first reference value corresponding to said one of the predetermined luminance codes and the luminance value of one of the data points corresponding to the sub-pixel and said one of the predetermined luminance codes. In this embodiment, the second reference luminance value of each of the second reference data points for each of the sub-pixels is obtained by subtracting the first reference luminance value that corresponds to the predetermined luminance code of the second reference data point from the luminance value of one of the data points that corresponds to the sub-pixel and the predetermined luminance code of the second reference data point.

Upon generating the second reference data points, the computer device 3 performs, for each of the sub-pixels, curve fitting on the corresponding second reference data points to obtain a corresponding second polynomial function h(x) that describes a second fitting curve fitting the corresponding second reference data points and that has a degree of M, where M≤N. Particularly, in order to obtain good curve fitting and lower complexity in computation, M=N−1 when N>1, and M=N when N=1, but this disclosure is not limited in this respect.

Then, the computer device 3 acquires, for each of the sub-pixels, a respective first data-points curve function p(x) which describes the data-points fitting curve based on the first polynomial function g(x) and the corresponding second polynomial function h(x), and extracts, for each of the sub-pixels, a function parameter set composed of a plurality of function parameters from the first data-points curve function p(x) that corresponds to the sub-pixel. In this embodiment, the first data-points curve function p(x) is acquired according to:

p(x)=g(x)+h(x)

Assuming that the first data-points curve function p(x) for an i^{th} one of the sub-pixels is a four-degree polynomial function of: p(x)=a_{fi}x⁴+b_{fi}x³+c_{fi}x²+d_{fi}x+e_{fi}, the function parameter set for p(x) is composed of the function parameters a_{fi}, b_{fi}, c_{fi}, d_{fi} and e_{fi}. At this time, the function parameters are in a form of floating points, which may result in difficulty in terms of data storage and circuit complexity. Accordingly, the computer device 3 performs, for each of the sub-pixels, floating-point quantization on the function parameter set that corresponds to the sub-pixel, in order to obtain a fixed-point parameter set that is used to form a second data-points curve function that describes the fitting curve for the sub-pixel (exemplified as a set of parameters aᵢ, bᵢ, cᵢ, dᵢ and eᵢ to form a second data-points curve function “y=aᵢx⁴+bᵢx³+cᵢx²+dᵢx+eᵢ” that describes the fitting curve (C2) in FIG. 3) conforming to a single-pixel criterion and a pixel-difference criterion. In this embodiment, the single-pixel criterion relates, for each of the sub-pixels, to a fitting deviation that corresponds to the sub-pixel and that relates to a mismatch between the fitting curve (or the second data-points curve function) and the data points corresponding to the sub-pixel; and the pixel-difference criterion relates, for each of the sub-pixels, to differences between the fitting deviation corresponding to the sub-pixel and the fitting deviations corresponding to some of the sub-pixels that are adjacent to the sub-pixel. After the floating-point quantization, different but similar function parameter sets for different sub-pixels may be converted into the same fixed-point parameter set, so that a total number of fixed-point parameter sets may be significantly less than a total number of function parameter sets.

In this embodiment, the floating-point quantization is a trial-and-error process, which may include multiple cycles to ultimately obtain the fixed-point parameter set, where each cycle includes a quantization step, and a determination step following the quantization step. Relevant description that follows will be made with respect to a single sub-pixel.

In the quantization step, the computer device 3 performs floating-point quantization on the function parameter set based on a fixed-point resolution and a quantization algorithm combination to acquire a trial parameter set which is used to form a trial curve function that describes a trial fitting curve for the sub-pixel and which is in a form of fixed points. The fixed-point resolution refers to a number of bits used to represent a parameter. Higher fixed-point resolution means that the parameter is represented by a larger number of bits. However, different parameters may be represented using different numbers of bits. In this embodiment, the quantization algorithm combination is a combination of quantization algorithms which respectively correspond to the function parameters, and each of which is one of a rounding function (e.g., a function to round a number to a nearest integer), a ceiling function (e.g., a function to output the least integer greater than or equal to an input number) and a floor function (e.g., a function to output the greatest integer smaller than or equal to an input number). In other words, the quantization algorithms used for different function parameters may be different. Techniques for floating-point quantization should be well known to persons skilled in the art, so details thereof are omitted herein for the sake of brevity.

In the determination step, the computer device 3 determines whether the trial parameter set for the sub-pixel conforms to both of the single-pixel criterion and the pixel-difference criterion.

In this embodiment, for a sub-pixel, the fitting deviation is defined as:

Dev=(F−ABS)./R×100%

where “Dev” represents the fitting deviation which is represented as a matrix composed of fitting deviation values that respectively correspond to the predetermined luminance codes, “F” represents a fitting-data matrix composed of values of f(x) (a curve function used to fit the sub-pixel) respectively corresponding to the predetermined luminance codes, “ABS” represents a data-point matrix composed of the luminance values of the data points, “./” represents element-by-element right matrix division, and R represents a reference matrix composed of reference luminance values respectively corresponding to the predetermined luminance codes. Since a sub-pixel corresponds to a data point set composed of a set of data points, the fitting deviation includes a set of fitting deviation values each of which is a difference between the curve function used to fit the sub-pixel, and a respective one of the data points of the data point set acquired for the sub-pixel. For instance, assuming that the data points corresponding to the sub-pixel have luminance values of L16, L32, L64, L128, L192 and L240 and respectively correspond to the predetermined luminance codes of 16, 32, 64, 128, 192 and 240, and the reference luminance values are r16, r32, r64, r128, r192 and r240 and respectively correspond to the predetermined luminance codes of 16, 32, 64, 128, 192 and 240, the fitting-data matrix (F), the data-point matrix (ABS) and the reference matrix (R) would respectively be:

F=[f(16) f(32) f(64) f(128) f(192) f(240)],

ABS=[L16 L32 L64 L128 L192 L240], and

R=[r16 r32 r64 r128 r192 r240],

and the fitting deviation (Dev) for the sub-pixel would be:

$$Dev = [ D 16 D 32 D 64 D 128 D 192 D 240 ] = [ \frac{f ( 16 ) - L 16}{r 16} \frac{f ( 32 ) - L 32}{r 32} \frac{f ( 64 ) - L 64}{r 64} \frac{f ( 128 ) - L 128}{r 128} \frac{f ( 192 ) - L 192}{r 192} \frac{f ( 240 ) - L 240}{r 240} ] \times 100 \%$$

In one embodiment, each of the reference luminance values may be the average of the luminance values of the data points that correspond to the predetermined luminance code to which the reference luminance value corresponds. In one embodiment, the reference luminance values may correspond to a curve representing a relationship between luminance codes and luminance desired by the designer, such as the curve (C1) in FIG. 3.

In this embodiment, the single-pixel criterion is defined by setting, for each of the predetermined luminance codes, a deviation range for the corresponding one of the fitting deviation values of the fitting deviation (Dev), and requires that each of the fitting deviation values falls within the corresponding deviation range. The deviation ranges that respectively correspond to the predetermined luminance codes may be represented as a single-pixel deviation matrix (Sp). Following the example above, the single-pixel deviation matrix (Sp) may be exemplarily represented as:

Sp=[12% 8% 8% 5% 4% 4%],

which means that the single-pixel criterion requires that |D16|<12%, |D32|<8%, |D64|<8%, |D128|<5%, |D192|<4% and |D240|<4%.

In this embodiment, the pixel-difference criterion is defined by setting, for each of the predetermined luminance codes, a deviation difference range for a deviation difference between the fitting deviation values respectively corresponding to the sub-pixel and one of adjacent sub-pixels for the sub-pixel, and requires that the deviation difference falls within the corresponding deviation difference range. It is noted that the adjacent sub-pixels for a particular sub-pixel refer to some of the sub-pixels of the display panel 10 that are adjacent to the particular sub-pixel and that correspond to the same color element as the particular sub-pixel. The adjacent sub-pixels for the particular sub-pixel may be defined as required by the designer. For example, the adjacent sub-pixels for a particular sub-pixel may refer to the sub-pixels respectively at the right, left, upper and lower sides of the particular sub-pixel (totally four adjacent sub-pixels for the particular sub-pixel) in one embodiment, and refer to the sub-pixels respectively at the right, left, upper, lower, upper-right, upper left, lower-right and lower-left sides of the particular sub-pixel (totally eight adjacent sub-pixels for the particular sub-pixel) in another embodiment. The deviation difference ranges that respectively correspond to the predetermined luminance codes may be represented as a deviation difference matrix (Dd). Following the example above, the deviation difference matrix (Dd) may be exemplarily represented as:

Dd=[18% 12% 12% 8% 6% 6%]

which means that the pixel-difference criterion requires that |D16−D16_{adj}|<18%, |D32−D32_{adj}|<12%, |D64−D64_{adj}|<12%, |D128−D128_{adj}|<8%, |D192−D192_{adj}|<6% and |D240−D240_{adj}|<6%, where D16_{adj}, D32_{adj}, D64_{adj}, D128_{adj}, D192_{adj}, D240_{adj} respectively represent the fitting deviation values corresponding to an arbitrary one of the adjacent sub-pixels for the sub-pixel.

When the computer device 3 determines that the trial parameter set for the sub-pixel conforms to both of the single-pixel criterion and the pixel-difference criterion, the trial parameter set is used as the fixed-point parameter set.

When the computer device 3 determines that the trial parameter set for the sub-pixel does not conform to either one of the single-pixel criterion and the pixel-difference criterion, the quantization step is repeated for the next cycle, in which another quantization algorithm or a higher fixed-point resolution is used for floating-point quantization.

In one embodiment, the quantization step is performed using the rounding function in the first cycle. In the subsequent cycle(s) (if needed), different quantization algorithm combinations may be used to obtain another trial parameter set under the same fixed-point resolution (e.g. 8 bits). When it is concluded that only changing the quantization algorithm combinations cannot make the resultant trial parameter set conform with both the single-pixel criterion and the pixel-difference criterion, a higher fixed-point resolution (e.g., 10 bits) may be used in the later cycles. Accordingly, by such iterative operation, a proper trial parameter set that conforms to both of the single-pixel criterion and the pixel-difference criterion may be found to serve as the fixed-point parameter set. Through the abovementioned floating-point quantization, a large number of the function parameter sets, which are in a form of floating points and which respectively correspond to all of the sub-pixels of the display panel 10, may be transformed into a small number of the fixed-point parameter sets, each corresponding to a unique second data-points curve function. In this embodiment, each of the second data-points curve function is a measurement-based curve function obtained based on a data point set, and serving as one of the fitting functions to be obtained in step 202. The way to obtain a plurality of measurement-based curve functions is not limited to those introduced above. In some embodiments, the floating-point quantization may be omitted, and the first data-points curve functions can be the measurement-based curve functions. In some embodiments, the measurement-based curve functions can be generated using traditional polynomial approximation or piecewise polynomial approximation, with a degree greater than or equal to two. In addition, use of the two-stage curve fitting algorithm is not necessary for this disclosure.

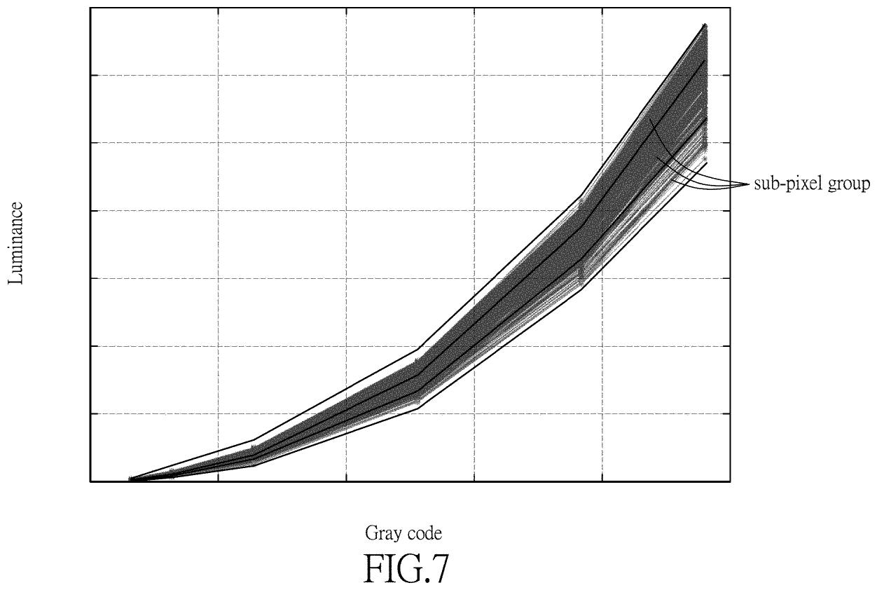

It is noted that the fitting functions obtained in step 202 may include, but not limited to the measurement-based curve functions. In some embodiments, one or more reference curve functions may be further acquired based on the data point sets, and serve as a part of the fitting functions obtained in step 202. For example, the computer device 3 may classify the sub-pixels into multiple sub-pixel groups based on the data point sets acquired for the sub-pixels. As exemplified in FIG. 7, the data point sets, each corresponding to a respective sub-pixel, are classified into three sub-pixel groups based on the relationship between luminance codes and luminance. Subsequently, for each of the sub-pixel groups, the computer device 3 acquires a reference curve function based on the data point sets acquired for the sub-pixels in the sub-pixel group. In one implementation, the computer device 3 obtains a reference data point set for each of the sub-pixel groups. The reference data point set includes a plurality of reference data points, each of which is composed of a respective one of the predetermined luminance codes and a reference luminance value that is calculated by averaging the luminance values of the data points that are measured at the said predetermined luminance code for the sub-pixels in the sub-pixel group. In other words, the reference data point set obtained for each of the sub-pixel groups is an average of the data point sets that correspond to the sub-pixels belonging to the sub-pixel group. Then, the computer device 3 performs, for each of the sub-pixel groups, curve fitting on the corresponding reference data points to obtain the reference curve function for the sub-pixel group. In another implementation, the computer device 3 may average, for each of the sub-pixel groups, the measurement-based curve functions that are obtained by performing curve fitting on the data point sets of the sub-pixels of the sub-pixel group to obtain the reference curve function for the sub-pixel group.

The fitting functions obtained in step 202 may be further reduced in number for conducting demura operation. In step 204, the computer device 3 determines, for each of the sub-pixels, a filtered fitting function, which is one of the fitting functions that are obtained in step 202, to fit the data point set acquired for the sub-pixel. The filtered fitting function conforms to a predetermined filtering criterion with respect to the sub-pixel. The predetermined filtering criterion may include only the single-pixel criterion or include both of the single-pixel criterion and the pixel-difference criterion. It is noted that, in this embodiment, although a measurement-based curve fitting function that conforms with both of the single-pixel criterion and the pixel-difference criterion has been determined for each of the sub-pixels during the floating-point quantization, there may be another fitting function, among all the fitting functions determined for the sub-pixels, that also conforms with the predetermined filtering criterion (including only the single-pixel criterion or both of the single-pixel criterion and the pixel-difference criterion) with respect to the sub-pixel.

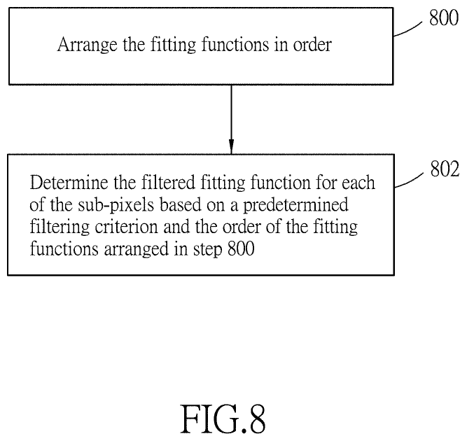

FIG. 8 is a flow chart exemplarily illustrating steps to determine the filtered fitting function for each of the sub-pixels. In step 800, the computer device 3 arranges the fitting functions obtained in step 202 in order, wherein the measurement-based curve functions of the fitting functions are arranged from a highest frequency of occurrence among the measurement-based curve functions to a lowest frequency of occurrence among the measurement-based curve functions. It is noted that the measurement-based curve functions acquired for different sub-pixels (data point sets) may be the same, so for some measurement-based curve functions, the number of occurrence would be greater than one, and therefore the measurement-based curve functions may have different frequencies of occurrence.

In step 802, for each of the sub-pixels, the computer device 3 determines the filtered fitting function by taking one of the fitting functions that has the highest order (first order) among those of the fitting functions conforming to the predetermined filtering criterion with respect to the sub-pixel to be the filtered fitting function. As an example, in case where the fitting functions obtained in step 202 include only the measurement-based curve functions, it is assumed that a measurement-based curve function p_{A}(x) that conforms to both of the single-pixel criterion and the pixel-difference criterion has been found for a sub-pixel (S_{A}) during the floating-point quantization, and that a measurement-based curve function p_{B}(x) that conforms to both of the single-pixel criterion and the pixel-difference criterion has been found for another sub-pixel (S_{B}) during the floating-point quantization. If the measurement-based curve function p_{B}(x) also conforms to the predetermined filtering criterion with respect to the sub-pixel (S_{A}) and has the highest order (i.e., the highest frequency of occurrence) among those of the fitting functions conforming to the predetermined filtering criterion with respect to the sub-pixel (S_{A}), the computer device 3 would make the measurement-based curve function p_{B}(x) serve as the filtered fitting function for the sub-pixel (A).

It is noted that, in a case that the fitting functions obtained in step 202 further include the reference curve function(s), the measurement-based curve function that has the highest frequency of occurrence may not be the fitting function that has the highest order. Like the previous case where the sub-pixels are classified into multiple sub-pixel groups, for each of the sub-pixel groups, the corresponding reference curve function may be arranged to have the highest order for the sub-pixels of the sub-pixel group. In this situation, for each of the sub-pixels, the computer device 3 will take the reference curve function acquired for the corresponding one of the sub-pixel groups to be the filtered fitting function for the sub-pixel when the reference curve function acquired for the corresponding one of the sub-pixel groups conforms to the predetermined filtering criterion with respect to the sub-pixel. On the other hand, for each of the sub-pixels, when the reference curve function acquired for the corresponding one of the sub-pixel groups (one of the sub-pixel groups including the sub-pixel) does not conform to the predetermined filtering criterion with respect to the sub-pixel, the computer device 3 will determine one of the measurement-based curve functions that has the highest order among those of the measurement-based curve functions corresponding to the corresponding one of the sub-pixel groups and conforming to the predetermined filtering criterion with respect to the sub-pixel to be the filtered fitting function for the sub-pixel.

Through such an algorithm, those of the measurement-based curve functions that have lower frequencies of occurrence may be excluded, so a total number of the fitting functions used for demura operation may be further reduced.

When the parameters of the filtered fitting functions determined in step 204 for the sub-pixels are floating points, the floating-point quantization may be performed at this moment, but this disclosure is not limited to such.

Parameter sets of the filtered fitting functions determined in step 204 for the sub-pixels (referring to as filtered parameter sets hereinafter) may be stored in a non-volatile memory (e.g., a flash memory, EEPROM, etc.) of the display panel 10 for subsequent use by the processor 20 of the computerized device 10.

Then, a plurality of demura lookup tables are generated based on the desired relationship between luminance codes and luminance and based on the filtered parameter sets corresponding to a portion of the sub-pixels to achieve fast and simple demura operation. Each demura lookup table is used to output a modified luminance code in response to a luminance code input thereto. However, it is not necessary to use a demura lookup table for demura operation of every single sub-pixel. Some embodiments may use the demura lookup tables for demura operation of only a portion of the sub-pixels, and use other demura method(s), such as logic circuits, for demura operation of the other sub-pixels. Accordingly, the portion of the sub-pixels of which the demura operation uses the demura lookup tables are denoted as target sub-pixels hereinafter. In one implementation, it is the computer device 3 that calculates the demura lookup tables based on the desired relationship between luminance codes and luminance and the filtered parameter sets, and the demura lookup tables are stored in the non-volatile memory unit 50 on the main board of the computerized device 1 in the production line. In another implementation, the filtered parameter sets and the desired relationship between luminance codes and luminance and may be stored in a non-volatile memory (e.g., a flash memory module, an EEPROM, etc.) on the display panel 10, and, when the computerized device 1 is turned on for the first time, the processor 20 may read the filtered parameter sets and the desired relationship between luminance codes and luminance from the display panel 10, calculate the demura lookup tables, and store the demura lookup tables thus calculated in the non-volatile memory unit 50. In this embodiment, all of the sub-pixels of the display panel 10 are the target sub-pixels. After the demura lookup tables are established, the computerized device 1 may perform demura operation for the target sub-pixels by adjusting the luminance codes corresponding to the target sub-pixels according to the demura lookup tables.

In the case depicted in FIG. 3, for example, when control for displaying a to-be displayed image includes a luminance code of 175 for the sub-pixel, the sub-pixel is expected to have luminance of L1 according to the curve (C1). However, the sub-pixel may only have luminance of L2 in correspondence to the luminance code of 175 according to the target fitting curve (C2). In order to achieve the desire luminance of (L1), the demura lookup table for the sub-pixel may be established to have an output of a luminance code of 200 in response to an input of a luminance code of 175. In other words, the demura lookup table is established to reduce the difference between the curve (C1) and the curve (C2) for the sub-pixel at each of the luminance codes.

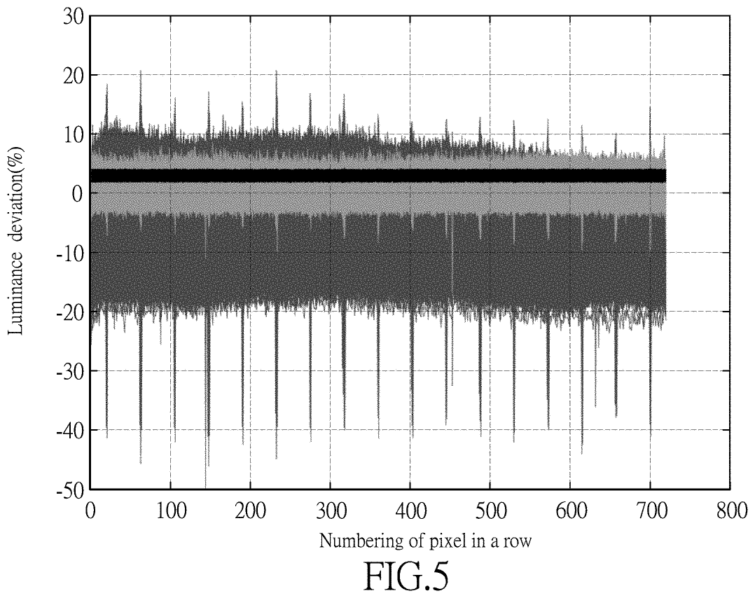

FIG. 5 is a plot showing experimental data for a display panel which has a resolution of 720×1280 (720 columns and 1280 rows of pixels) at a luminance code of 192. It is noted that the dark gray part is composed of 1280 dark gray curves each indicating a luminance deviation of the sub-pixels along a respective row consisting of 720 pixels relative to the desired relationship between luminance codes and luminance when no demura operation is performed; that the light gray part is composed of 1280 light gray curves each indicating a luminance deviation of the sub-pixels along a respective row consisting of 720 pixels relative to the desired relationship between luminance codes and luminance when a conventional demura operation that uses piecewise linear approximation and conventional floating-point quantization for curve fitting is performed; and that the black part is composed of 1280 black curves each indicating a luminance deviation of the sub-pixels along a respective row consisting of 720 pixels relative to the desired relationship between luminance codes and luminance when the two-stage curve fitting and the iterative floating-point quantization are used for demura operation. Evidently, the demura operation based on the two-stage curve fitting and the floating-point quantization process that employs the single-pixel criterion and the pixel-difference criterion according to this disclosure causes the display panel to have better luminance uniformity.

After the demura lookup tables are stored in the non-volatile memory element (e.g., the non-volatile memory unit 50 on the main board in this embodiment) of the computerized device 1 in which the display panel 10 is assembled, the computerized device 1 can load the demura lookup tables into the volatile memory element (e.g., the first volatile memory unit 30 and/or the second volatile memory unit 40 on the main board in this embodiment, or a volatile memory unit on the display panel 10 or other parts of the computerized device 1 in other embodiments) during operation, and thus display images with good luminance uniformity based on the demura lookup tables loaded into the volatile memory element. In some cases where a total number of the demura lookup tables is very small, the demura lookup tables may all be stored in the limited storage capacity of the SRAM, which is for the source driver ICs of the display panel 10, for use by the display panel 10 to perform demura operation. In some cases, the SRAM for the source driver ICs of the display panel 10 may be used to store only the demura lookup tables that correspond to the most representative filtered parameter sets (e.g., corresponding to more than 90% of the sub-pixels)), and demura operations for the other sub-pixels may be performed through computation by logic circuits. In this embodiment, it is assumed that the SRAM for the source driver ICs of the display panel 10 is unable to store all the demura lookup tables, so the demura operation for all sub-pixels may be performed by the components mounted on the main board of the computerized device 1, and not by the display panel 10.

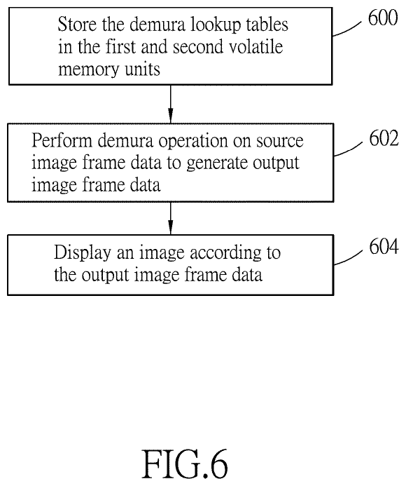

In this embodiment, the non-volatile memory unit 50 has pre-stored therein the demura lookup tables that are established based on luminance uniformity of the display panel 10. Each sub-pixel of the display panel 10 corresponds to one of the demura lookup tables, which is predefined based on an intrinsic relationship between luminance codes and luminance of the sub-pixel, and a desired relationship between luminance codes and luminance for all sub-pixels. FIG. 6 illustrates how the processor 20 implements the demura operation in this embodiment. When the computerized device 1 is turned on, the processor 20 loads the demura lookup tables from the non-volatile memory unit 50 (note that the demura lookup tables may be calculated and stored in the non-volatile memory unit 50 either on the production line or during initialization process of the computerized device 1 when the computerized device 1 is turned on for the first time), and stores the demura lookup tables in the first and second volatile memory units 30, 40 for higher access speed (step 600). In this embodiment, the computerized device 1 is a smartphone, and the processor 20 is the application processor of the smartphone, so the processor 20 may load a portion of the demura lookup tables into the SRAM mounted on the main board of the smartphone, which serves as the first volatile memory unit 30, and load the remaining portion of the demura lookup tables into the DRAM mounted on the main board of the smartphone, which serves as the second volatile memory unit 40.

In this embodiment, the first volatile memory unit 30 is an SRAM unit and the second volatile memory unit 40 is a DRAM unit. Although the SRAM has a higher access speed in comparison to the DRAM, the SRAM is much more expensive than the DRAM, so the SRAM usually has much smaller storage capacity than the DRAM in an electronic device. In consideration of cost, a number of the demura lookup tables that can be stored in the SRAM is predetermined, and all other demura lookup tables must be stored in another memory unit of which the access speed is relatively low, such as the DRAM. To efficiently make use of the SRAM, the demura lookup tables are divided into a first group to be stored in the SRAM, and a second group to be stored in the DRAM, where the first group consists of a predetermined table number (e.g., 256, 128, 64, etc., depending on the storage capacity of the SRAM) of demura lookup tables that correspond to a high percentage, e.g., more than ninety percent, of the sub-pixels of the display panel 10, and the second group consists of the demura lookup tables other than those of the first group. Note that the method of this disclosure is still workable even if the SRAM only stores the demura lookup tables that correspond to less than ninety percent of the sub-pixels of the display panel, but the bandwidth of the DRAM may be occupied by the display operation at a relatively higher ratio, which may adversely affect other operations that may also require to make use of the DRAM. In one example, the demura lookup tables for ninety percent or more of the sub-pixels are stored in the SRAM that has the higher access speed and only a relatively small number of the sub-pixels correspond to the demura lookup tables stored in the DRAM that has the lower access speed, so the demura operation for an entire frame to be displayed on the display panel 10 may be completed within a predefined time limit. It is noted that this embodiment uses the processor 20 of the computerized device 1 (e.g., the application processor of the smartphone) to perform demura operation, so the SRAM which is employed by the processor 20 and which usually has a relatively large storage capacity in comparison to the SRAM used by source driver ICs of the display panel 10 may have sufficient capacity to store the required number (the predetermined table number) of the demura lookup tables. In detail, a number of the filtered parameter sets are selected from all of the filtered parameter sets, where the number equals the predetermined table number. Then, the first group of the demura lookup tables is generated based on the selected ones of the filtered parameter sets (amounting to the predetermined table number) and the desired relationship between luminance codes and luminance, and the second group of the demura lookup tables is generated based on the filtered parameter sets other than the selected ones and the desired relationship between luminance codes and luminance.

In one exemplary implementation where a display panel has 1800×900=1,620,000 sub-pixels for each color element, 1,620,000 corresponding function parameter sets may be converted into 519 fixed-point parameter sets by using the two-stage curve fitting and the iterative floating-point quantization process according to this disclosure, where the most representative 64 (out of 519) fixed-point parameter sets correspond to 91.61% of the 1,620,000 sub-pixels, while the other 455 (out of 519) fixed-point parameter sets correspond to 8.39% of the 1,620,000 sub-pixels. In a case where steps 202 and 204 (see FIG. 2) are not used to further reduce the number of parameter sets for performing demura operation, the manufacturer may decide to employ the SRAM whose capacity allows storage of only 64 demura lookup tables for storing the first group of the demura lookup tables (corresponding to 91.61% of the sub-pixels), and to employ the DRAM for storing the second group of the demura lookup tables (the other 455 demura lookup tables) when the computerized device 1 is in use, thereby using the SRAM (first volatile memory unit 30), which is usually faster and more expensive than the DRAM (second volatile memory unit 40), in an efficient way, and achieving the required data transferring speed without inducing a large increase in cost. When steps 202 and 204 are used to further reduce the parameter sets required for performing demura operation, cost in use of the SRAM and the DRAM may be further reduced. On the other hand, with poor polynomial approximation (curve fitting) and a poor quantization rule, the 1,620,000 function parameter sets may be converted into, for example, 2199 floating-point parameter sets, where the most representative 64 (out of 2199) floating-point parameter sets correspond to only 49.15% of the 1,620,000 sub-pixels, and the most representative 256 (out of 2199) floating-point parameter sets correspond to 87.73% of the 1,620,000 sub-pixels. Accordingly, the manufacturer may employ the SRAM with greater capacity to store the 256 demura lookup tables that correspond to 87.73% of the sub-pixels when the computerized device 1 is in use, thereby increasing the cost while the overall performance is still inferior than that of the former example (where 91.61% of the sub-pixels correspond to 64 demura lookup tables stored in the SRAM).

In step 602, the processor 20 performs demura operation on pre-demura image frame data to generate post-demura image frame data serving as output image frame data and including a plurality of luminance codes which respectively correspond to the luminance codes of the pre-demura image frame data. The pre-demura image frame data may originate from an image source (e.g., the Internet, storage devices, multimedia service providers, media players, other image processing blocks, etc.). In this embodiment, the processor 20 performs the demura operation by acquiring, for each of the luminance codes of the pre-demura image frame data, the corresponding one of the luminance codes of the post-demura image frame data according to a corresponding one of the demura lookup tables (i.e., a demura lookup table corresponding to a sub-pixel to which the luminance code of the pre-demura image frame data corresponds). The correspondences between the sub-pixels and the demura lookup tables may be pre-stored in the non-volatile memory unit 50 and/or a non-volatile memory on the display panel 10 in a form of a lookup table (correspondence lookup table), and may be loaded to the DRAM when the computerized device 1 is turned on. However, it is noted that the demura operation is not limited to that used in this embodiment. In other embodiments, the demura operation may be performed through calculation using logic circuits, which may be disposed on either the main board or the display panel 10.

In one example, the processor 20 reads out the luminance codes of the pre-demura image frame data one by one from the DRAM to acquire, based on the correspondence lookup table, a memory address for acquiring a corresponding luminance code for the output image frame data. In practice, a first luminance code read out by the processor 20 from a specific memory address may be the luminance code of the pre-demura image frame data for the first sub-pixel, so the processor 20 acquires information indicating which one of the demura lookup tables corresponds to the first sub-pixel and where the corresponding demura lookup table is stored (in the SRAM or the DRAM) according to the correspondence lookup table, and then acquires the corresponding luminance code for the first sub-pixel to be part of the post-demura image frame data (output image frame data in this embodiment) (i.e., one of the luminance codes of the post-demura image frame data that corresponds to the first sub-pixel) according to the demura lookup table that corresponds to the first sub-pixel; a second luminance code read out by the processor 20 from a memory address next to the specific memory address of a first DRAM block of the DRAM may be the luminance code of the pre-demura image frame data that corresponds to the second sub-pixel, so the processor 20 acquires information indicating which one of the demura lookup tables corresponds to the second sub-pixel and where the corresponding demura lookup table is stored (in the SRAM or the DRAM) according to the correspondence lookup table, and then acquires the corresponding luminance code for the post-demura image frame data for the second sub-pixel according to the demura lookup table that corresponds to the second sub-pixel; so on and so forth.

Based on the luminance code of the pre-demura image frame data for a pixel and the correspondence read out from the DRAM, the processor 20 can acquire a memory address of the corresponding luminance code for the post-demura image frame data for the same pixel, read out a corresponding luminance code for the post-demura image frame data from the corresponding SRAM or DRAM according to the acquired memory address, and store the luminance code for the post-demura image frame data for that pixel in the DRAM. The processor 20 may provide the post-demura image frame data to the source driver ICs after all of the luminance codes for the post-demura image frame data have been acquired and stored in the DRAM, but this disclosure is not limited in this respect.

In step 604, the processor 20 provides the output image frame data (the post-demura image frame data in this embodiment) to the source driver ICs to perform digital-to-analog conversion and to drive the display panel 10 to display the image of the frame based on the output image frame data. In one embodiment, the output image frame data may be transmitted in a form of analog voltages. Details of this step should be well known in the art and will be omitted herein for the sake of brevity. By using the SRAM on the main board to store the first group of the demura lookup tables and using the DRAM on the main board to store the second group of the demura lookup tables, speed of demura operation using these demura lookup tables should be fast enough to fulfill requirements for the majority of general applications. However, in some applications that require very fast demura speed and very good performance, such as applications for virtual reality or augmented reality, the demura operation may be performed using the demura lookup tables stored in the SRAM and DRAM on the main board of the computerized device 1, in cooperation with logic circuits that are designed for demura operation.

In summary, this disclosure enhances luminance uniformity of a display panel in two aspects that are independent with respect to each other. One aspect is the two-stage curve fitting for obtaining a good data-points fitting curve that fits the data points measured by the AOI system 2 well. The two-stage curve fitting may (but not necessarily) cooperate with the iterative floating-point quantization process to convert, based on the single-pixel criterion and the pixel-difference criterion, the large number of the function parameter sets into the small number of the fixed-point parameter sets for the sub-pixels. Then, the number of the parameter sets may be further reduced by using the predetermined filtering criterion, which may include only the single-pixel criterion or both of the single-pixel criterion and the pixel-difference criterion, thereby reducing hardware requirement for demura operation while maintaining good demura effect. In addition, by establishing the demura lookup tables and dividing them into two groups, one of which includes a predetermined number of the most representative demura lookup tables (preferably corresponding to more than 90% of sub-pixels) and is to be stored in the SRAM, and the other one of which is to be stored in the DRAM, the high-speed yet expensive SRAM may be efficiently utilized, thereby achieving good cost control while providing satisfactory performance.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of determining fitting functions for sub-pixels of a same color element of a display panel, the method to be performed by a computer device and comprising:
acquiring, for each of the sub-pixels, a data point set that includes a plurality of data points respectively corresponding to multiple predetermined luminance codes, wherein each of the data points is composed of the corresponding one of the predetermined luminance codes and a luminance value of the sub-pixel measured at the corresponding one of the predetermined luminance codes;
obtaining a plurality of fitting functions by performing curve fitting based on the data point sets acquired for the sub-pixels; and
for each of the sub-pixels, determining a filtered fitting function, which is one of the fitting functions that conforms to a predetermined filtering criterion, to fit the data point set acquired for the sub-pixel, the filtered fitting functions determined for the sub-pixels being to be used in demura operation for the display panel;
wherein, for each of the sub-pixels, the predetermined filtering criterion includes a single-pixel criterion that relates to a fitting deviation, which corresponds to the sub-pixel and which relates to a mismatch between the filtered fitting function and the data points corresponding to the sub-pixel.

2. The method of claim 1, wherein each of the fitting functions is a polynomial function of which a degree is greater than or equal to two.

3. The method of claim 1, wherein the obtaining a plurality of fitting functions includes:
acquiring, for each of the sub-pixels, a measurement-based curve function that serves as one of the fitting functions, by performing curve fitting on the data point set acquired for the sub-pixel;
said method further comprising:
arranging the fitting functions in order, wherein the measurement-based curve functions of the fitting functions are arranged from a highest frequency of occurrence among the measurement-based curve functions to a lowest frequency of occurrence among the measurement-based curve functions;
wherein, for each of the sub-pixels, the filtered fitting function is one of the fitting functions that has a highest order among those of fitting functions conforming to the predetermined filtering criterion with respect to the sub-pixel.

4. The method of claim 1, wherein the obtaining a plurality of fitting functions includes:
classifying the sub-pixels into multiple sub-pixel groups based on the data point sets acquired for the sub-pixels; and
for each of the sub-pixel groups, acquiring a reference curve function based on the data point sets acquired for the sub-pixels of the sub-pixel group;
wherein, for each of the sub-pixels, the filtered fitting function is the reference curve function acquired for the corresponding one of the sub-pixel groups when the reference curve function acquired for the corresponding one of the sub-pixel groups conforms to the predetermined filtering criterion with respect to the sub-pixel.

5. The method of claim 4, wherein the acquiring the reference curve function for each of the sub-pixel groups includes:
obtaining, for the sub-pixel group, a reference data point set that includes a plurality of reference data points, each of the reference data points is composed of a respective one of the predetermined luminance codes and a reference luminance value that is calculated by averaging the luminance values of the data points that are measured at the corresponding one of the predetermined luminance codes for the sub-pixels of the sub-pixel group; and
performing curve fitting on the reference data points to obtain the reference curve function for the sub-pixel group.

6. The method of claim 4, wherein the acquiring the reference curve function for each of the sub-pixel groups includes:
obtaining a plurality of measurement-based curve functions for the sub-pixel group by performing curve fitting on each of the data point sets acquired for the sub-pixels of the sub-pixel group; and
averaging the measurement-based curve functions obtained for the sub-pixel group to obtain the reference curve function for the sub-pixel group.

7. The method of claim 4, wherein the obtaining a plurality of fitting functions includes, for each of the sub-pixel groups:
acquiring, for each of the sub-pixels of the sub-pixel group, a measurement-based curve function that serves as one of the fitting functions, by performing curve fitting on the data point set acquired for the sub-pixel;
said method further comprising, for each of the sub-pixel groups:
arranging the measurement-based curve functions acquired for the sub-pixels of the sub-pixel group in order from a highest frequency of occurrence among the measurement-based curve functions corresponding to the sub-pixel group to a lowest frequency of occurrence among the measurement-based curve functions corresponding to the sub-pixel group;
wherein, for each of the sub-pixels, when the reference curve function acquired for the corresponding one of the sub-pixel groups does not conform to the predetermined filtering criterion with respect to the sub-pixel, the filtered fitting function is one of the measurement-based curve functions that has a highest order among those of the measurement-based curve functions corresponding to one of the sub-pixel groups including the sub-pixel and conforming to the predetermined filtering criterion with respect to the sub-pixel.

8. The method of claim 1, wherein, for each of the sub-pixels, the predetermined filtering criterion further includes a pixel-difference criterion that relates to differences between the fitting deviation corresponding to the sub-pixel and the fitting deviations corresponding to some of the sub-pixels that are adjacent to the sub-pixel.

9. The method of claim 8, wherein, for each of the sub-pixels, the fitting deviation includes a set of fitting deviation values each of which is a difference between the filtered fitting function and a respective one of the data points of the data point set acquired for the sub-pixel, and the single-pixel criterion for the sub-pixel is defined by setting, for each of the predetermined luminance codes, a deviation range for the corresponding one of the fitting deviation values of the fitting deviation, and requires that each of the fitting deviation values falls within the corresponding deviation range; and
wherein the pixel-difference criterion for each of the sub-pixels is defined by setting, for each of the predetermined luminance codes, a deviation difference range for a deviation difference between the fitting deviation values respectively corresponding to the sub-pixel and one of adjacent sub-pixels for the sub-pixel, and requires that the deviation difference falls within the corresponding deviation difference range.

10. The method of claim 1, wherein, for each of the sub-pixels, the fitting deviation includes a set of fitting deviation values each of which is a difference between the filtered fitting function and a respective one of the data points of the data point set acquired for the sub-pixel, and the single-pixel criterion for the sub-pixel is defined by setting, for each of the predetermined luminance codes, a deviation range for the corresponding one of the fitting deviation values of the fitting deviation, and requires that each of the fitting deviation values falls within the corresponding deviation range.
